(19) United States
(12) Patent Application Publication
(10) Pub. No.: US 2023/0096745 A1
(43) Pub. Date: Mar. 30, 2023

(54) Polyamideimide Film-Forming Composition, Polyamideimide Film, Method of Preparing Polyamideimide Film-Forming Composition, Method of Producing Polyamideimide Film, and Uses of Polyamideimide Film-Forming Composition and Polyamideimide Film

(71) Applicants: SK Innovation Co., Ltd., Seoul (KR); SK ie technology Co., Ltd., Seoul (KR)

(72) Inventors: Cheol Min Yun, Daejeon (KR); So Young Lee, Daejeon (KR); Hye Jin Park, Daejeon (KR); Joo Hyun Lee, Daejeon (KR)

(21) Appl. No.: 17/895,147

(22) Filed: Aug. 25, 2022

(30) Foreign Application Priority Data
Aug. 26, 2021 (KR) 10-2021-0112858
Aug. 26, 2021 (KR) 10-2021-0113041

(51) Int. Cl. C08L 79/08; C08J 5/18; C08G 73/14

(52) U.S. Cl. CPC C08L 79/08; C08J 5/18; C08G 73/14; C08L 2201/08; C08L 2201/10; C08L 2203/16; C08L 2203/20

(57) ABSTRACT

The present disclosure relates to a polyamideimide film-forming composition, a polyamideimide film, a method of preparing a polyamideimide film-forming composition, a method of producing a polyamideimide film, and uses of a polyamideimide film-forming composition and a polyamideimide film. The polyamideimide film according to one embodiment prevents deterioration of colorless and transparent optical properties, has excellent visibility with no optical stains, has excellent heat resistance, is flexible, and has excellent bending properties.

### CROSS-REFERENCE TO RELATED APPLICATIONS

This application claims priority to Korean Patent Application No. 10-2021-0112858, filed Aug. 26, 2021, and Korean Patent Application No. 10-2021-0113041, filed Aug. 26, 2021, the disclosures of which are hereby incorporated by reference in their entireties.

### BACKGROUND OF THE INVENTION

### Field of the Invention

The following disclosure relates to a polyamideimide film-forming composition, a polyamideimide film, a method of preparing a polyamideimide film-forming composition, a method of producing a polyamideimide film, and uses of a polyamideimide film-forming composition and a polyamideimide film.

### Description of Related Art

Recently, lightness, slimness, and flexibility of a display device are becoming important. Since a glass substrate, which has been widely used in a display device according to the related art, is heavy, brittle, inflexible, and difficult for a continuous process, studies have been actively conducted to apply, to a flexible display device, a polymer substrate that is light, flexible, and easy for a continuous process in place of the glass substrate. In particular, polyamideimide (PAI), which is a polymer that is easy for synthesis and has excellent heat resistance and chemical resistance, has been mainly used.

It is required for a substrate material of a next-generation display device to have improved flexibility and mechanical properties for application to a foldable or flexible display device as well as excellent optical properties. Furthermore, it is required for the flexible display device to undergo a high-temperature process. In particular, in a case of an organic light emitting diode (OLED) device obtained through a low-temperature polysilicon (LIPS) process, excellent heat resistance is required because a process temperature is higher than 350° C. and is close to 500° C.

Meanwhile, a color of typical polyamideimide is brown or yellow, which is mainly caused by a charge transfer complex (CTC) formed by intramolecular and intermolecular interactions of polyamideimide. The color of polyamideimide lowers a light transmittance of a polyamideimide film and increases a birefringence of the polyamideimide film, which affects visibility of the display device.

In order to solve this problem, colorless and transparent polyamideimide may be prepared by reducing a CTC effect by combining or changing monomers having various structures. However, there is a trade-off relationship between the optical properties and the heat resistance. Therefore, extremely general results in which the optical properties of polyamideimide are improved, but the functionality is reduced or the heat resistance is deteriorated are obtained through these attempts. Accordingly, studies to improve color transparency and optical properties have been continuously conducted as long as the heat resistance and the mechanical properties of polyamideimide are not significantly deteriorated, but there is a limit to satisfying all of the conditions.

Therefore, there is a need to develop a substrate material of a display device that prevents deterioration of colorless and transparent performance, implements improved optical properties, satisfies excellent heat resistance, and thus may replace tempered glass.

### SUMMARY OF THE INVENTION

An embodiment of the present disclosure is directed to providing a polyamideimide film that may have an anti-reflection effect at a wide viewing angle and may remarkably reduce a mura phenomenon because it has a low thickness direction retardation in a visible ray region.

Another embodiment of the present disclosure is directed to providing a method of producing a polyamideimide film that prevents deterioration of colorless and transparent optical properties, has no optical stains, and has excellent visibility, heat resistance, and mechanical properties.

Still another embodiment of the present disclosure is directed to providing a polyamideimide film-forming composition that may simultaneously implement excellent optical properties and excellent heat resistance.

Still another embodiment of the present disclosure is directed to providing a method of preparing a polyamideimide film-forming composition that may simultaneously implement excellent optical properties and excellent heat resistance.

Still another embodiment of the present disclosure is directed to providing a cover window for a display device including the polyamideimide film.

Still another embodiment of the present disclosure is directed to providing a display device including the polyamideimide film.

In one general aspect, a polyamideimide film includes: a diamine-derived structural unit; a dianhydride-derived structural unit; and a diacid dichloride-derived structural unit,

wherein the diamine-derived structural unit includes a structural unit derived from a compound represented by the following Chemical Formula 1,

the dianhydride-derived structural unit includes a structural unit derived from a compound represented by the following Chemical Formula 2,

the diacid dichloride-derived structural unit includes a structural unit derived from any one of a compound represented by the following Chemical Formula 3 and a compound represented by the following Chemical Formula 4, and

the polyamideimide film has a thickness of 30 μm to 100 μm, a modulus of 4.0 GPa or more when measured according to ASTM E111, and an absolute value of a thickness direction retardation (Rth) of 600 nm or less when measured at a wavelength of 550 nm:

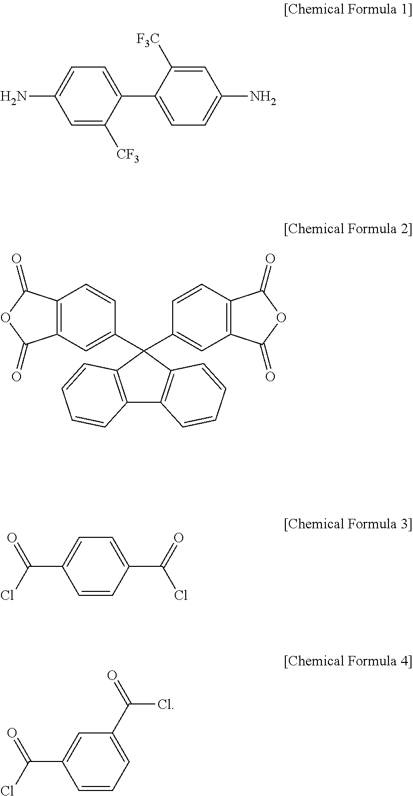 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

In another general aspect, a method of producing a polyamideimide film includes:

preparing a diamine solution by mixing a diamine containing a compound represented by the following Chemical Formula 1 with a solvent;

preparing a polyamideimide precursor by reacting a dianhydride containing a compound represented by the following Chemical Formula 2 with a diacid dichloride containing any one of a compound represented by the following Chemical Formula 3 and a compound represented by the following Chemical Formula 4 in the diamine solution; and

performing a heat treatment after applying the polyamideimide precursor to a substrate:

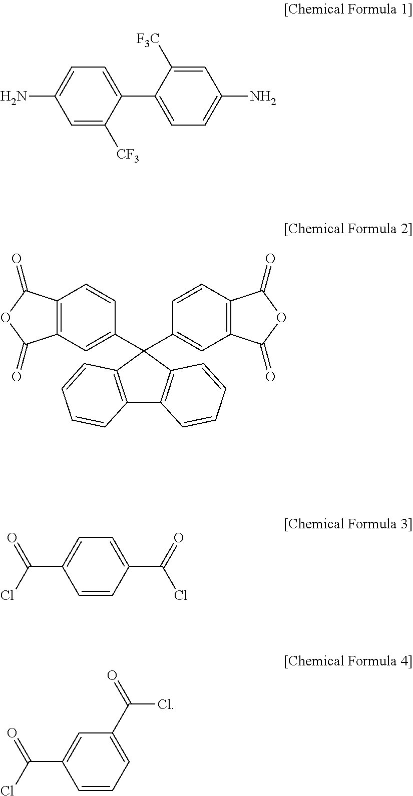 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

In still another general aspect, a polyamideimide film-forming composition contains:

polyamic acid or polyamideimide including a diamine-derived structural unit, a dianhydride-derived structural unit, and a diacid dichloride-derived structural unit; and

a mixed solvent including an amide-based solvent and a hydrocarbon-based solvent,

wherein the polyamideimide film-forming composition satisfies the following Expression 1, and

the diamine-derived structural unit includes a structural unit derived from a compound represented by the following Chemical Formula 1, the dianhydride-derived structural unit includes a structural unit derived from a compound represented by the following Chemical Formula 2, and the diacid dichloride-derived structural unit includes a structural unit derived from any one of a compound represented by the following Chemical Formula 3 and a compound represented by the following Chemical Formula 4:

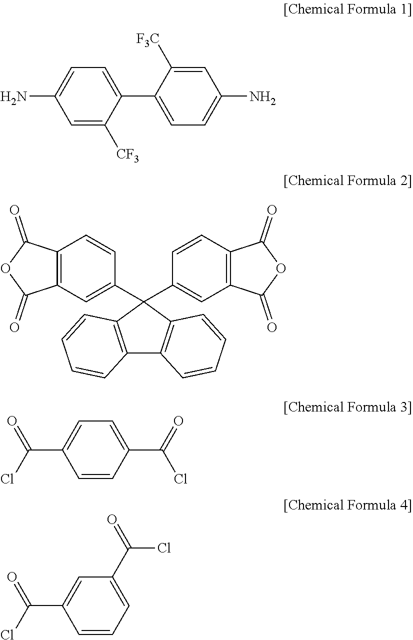

5,000 ≤V_{PAI} ≤15,000 [Expression 1]

wherein

V_{PAI} is a viscosity of the polyamideimide film-forming composition when a solid content is 17 wt % with respect to a total weight of the polyamideimide film-forming composition, and the viscosity is a viscosity (unit: cp) measured at 25° C. with a Brookfield rotational viscometer using a 52Z spindle based on a torque of 80% and a time of 2 minutes.

In still another general aspect, a method of preparing a polyamideimide film-forming composition includes:

preparing a polyamic acid solution by reacting a diamine containing a compound represented by the following Chemical Formula 1, a dianhydride containing a compound represented by the following Chemical Formula 2, and a diacid dichloride containing any one of a compound represented by the following Chemical Formula 3 and a compound represented by the following Chemical Formula 4 with each other in an amide-based solvent (step i); and

adjusting a viscosity by adding a hydrocarbon-based solvent to satisfy Expression 1 (step ii).

In still another general aspect, a cover window for a display device includes: the polyamideimide film; and a coating layer disposed on the polyamideimide film.

In still another general aspect, a display device includes the polyamideimide film.

Other features and aspects will be apparent from the following detailed description, the drawings, and the claims.

### DESCRIPTION OF THE INVENTION

Hereinafter, some embodiments of the present disclosure will be described in detail so that those skilled in the art may easily practice the embodiments of the present disclosure. However, the embodiments may be implemented in various different forms, and the present disclosure is not limited to the embodiments described herein. In addition, the following description is not intended to limit the scope of protection defined by the claims.

In addition, unless defined otherwise, the technical and scientific terms used in the present specification have the same meanings as commonly understood by those skilled in the art.

Throughout the present specification, unless explicitly described to the contrary, “comprising” any component may be understood to imply further inclusion of other components rather than the exclusion of any other components.

Hereinafter, unless otherwise specifically defined in the present specification, a “combination thereof” refers to mixing or copolymerization of constituents.

Hereinafter, unless otherwise specifically defined in the present specification, “A and/or B” may refer to an aspect including both A and B, and may refer to an aspect selected from A and B.

Hereinafter, unless otherwise specifically defined in the present specification, a “polymer” may include an oligomer and a polymer, and may include a homopolymer and a copolymer. The copolymer may include an alternating polymer, a block copolymer, a random copolymer, a branched copolymer, a crosslinked copolymer, or all of the copolymers.

Hereinafter, unless otherwise specifically defined in the present specification, “polyamic acid” may refer to a polymer including a structural unit having an amic acid moiety, and “polyamideimide” may refer to a polymer including a structural unit having an amide moiety and an imide moiety.

Hereinafter, unless otherwise specifically defined in the present specification, a polyamideimide film may be a film containing polyamideimide, and specifically, a high heat-resistant film produced by subjecting a dianhydride compound and a diacid dichloride to solution polymerization in a diamine compound solution to prepare polyamic acid, and then imidizing the polyamic acid by ring-closing dehydration at a high temperature.

Hereinafter, unless otherwise specifically defined in the present specification, a “mura phenomenon” may be construed as including all distortions that may be caused by light at a specific angle. Examples of the mura phenomenon include distortions caused by light, such as a black out phenomenon in which a screen looks black, a hot spot phenomenon, and a rainbow phenomenon exhibiting iridescent stains, which occur in a display device including a polyamideimide film.

Hereinafter, unless otherwise specifically defined in the present specification, it will be understood that when an element such as a layer, a film, a thin film, a region, or a plate, is referred to as being “above” or “on” another element, it may be “directly on” another element or may have an intervening element present therebetween.

Hereinafter, a polyamideimide film according to one embodiment will be described.

Although a polyimide film is attracting attention as a material to replace expensive tempered glass used as a cover window for a display device according to the related art, a distortion may easily occur due to light in the polyimide film. However, since a phenomenon caused by light is directly visible in the cover window formed on the outermost part of the display device, it is important to prevent a distortion due to light. Therefore, there is a need for a polyimide film that may fundamentally solve problems caused by the distortion due to light.

The polyamideimide film according to one embodiment is a polyamideimide film including a diamine-derived structural unit, a dianhydride-derived structural unit, and a diacid dichloride-derived structural unit. Specifically, the diamine-derived structural unit may include a structural unit derived from a compound represented by the following Chemical Formula 1, the dianhydride-derived structural unit may include a structural unit derived from a compound represented by the following Chemical Formula 2, and the diacid dichloride-derived structural unit may include a structural unit derived from any one of a compound represented by the following Chemical Formula 3 and a compound represented by the following Chemical Formula 4. In this case, the polyamideimide film may have a thickness of 30 μm to 100 μm, a modulus of 4.0 GPa or more when measured according to ASTM E111, and an absolute value of a thickness direction retardation (Rth) of 600 nm or less when measured at a wavelength of 550 nm.

Therefore, the polyamideimide film may have excellent transparency and may reduce a light distortion even at a thickness of 30 μm or more. In addition, the polyamideimide film has excellent optical properties in comparison to a polyamideimide film according to the related art, such as significantly preventing a rainbow mura exhibiting iridescent stains when viewed from various angles, and thus may be used as a cover window for a display device by replacing tempered glass.

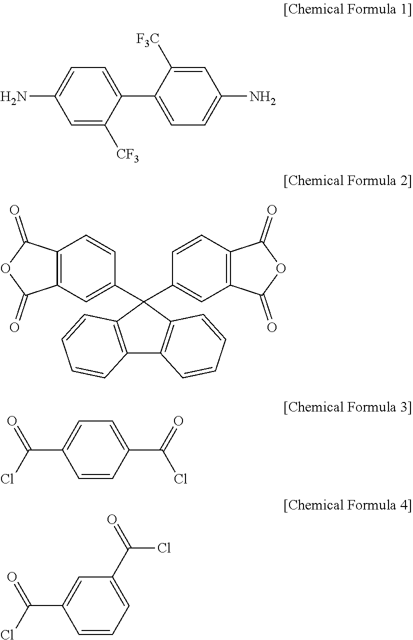

The thickness direction retardation value may be measured at a normal temperature before heating the film, and the normal temperature may be a temperature in a state in which the temperature is not artificially controlled. For example, the normal temperature may be 20° C. to 40° C., 20° C. to 30° C., or 23° C. to 26° C.

The polyamideimide film includes the structural units derived from the compounds represented by Chemical Formulas 1 and 2, and any one of a compound represented by Chemical Formula 3 and a compound represented by Chemical Formula 4, such that a distortion due to light may be further prevented in comparison to a polyamideimide film containing a polyamideimide polymer having a rigid structure. For example, in the polyamideimide film according to one embodiment, the dianhydride-derived structural unit may not include a rigid structural unit. For example, the dianhydride-derived structural unit may not include a structural unit derived from a dianhydride in which two anhydride groups are fused to one ring. The ring may be a single ring or a fused ring, and may be an aromatic ring, an aliphatic ring, or a combination thereof. Specifically, the dianhydride-derived structural unit may not include a structural unit derived from pyromellitic dianhydride (PMDA), a structural unit derived from cyclobutane-1,2,3,4-tetracarboxylic dianhydride (CBDA), or a combination thereof.

Accordingly, the polyamideimide film according to one embodiment may implement a low thickness direction retardation and may further improve visibility while being transparent at a thickness of 30 μm or more, such that a cover window including the polyamideimide film may further reduce eye fatigue of a user. In addition, the polyamideimide film may have further improved mechanical strength such as a modulus as well as excellent optical properties even at a thickness of 30 μm or more as described above, and thus may have further improved dynamic bending properties. Therefore, the polyamideimide film may be suitably applied as a cover window of a foldable display device or a flexible display device that repeatedly folds and unfolds.

A yellow index (YI) of the polyamideimide film according to one embodiment may be 4.0 or less when measured according to ASTM E313. Alternatively, the yellow index may be, for example, 3.8 or less, 3.5 or less, 3.0 or less, 1.0 or more and 4.0 or less, 1.0 or more and 3.5 or less, 1.5 or more and 3.5 or less, 2.0 or more and 3.5 or less, 2.5 or more and 3.5 or less, 2.8 or more and 3.4 or less, or 2.5 or more and 3.3 or less, but is not limited to the above range.

An elongation at break of the polyamideimide film according to one embodiment may be 10% or more. Alternatively, the elongation at break may be, for example, 11% or more, 13% or more, 15% or more, 10% or more and 20% or less, 10% or more and 17% or less, or 11% or more and 17% or less, but is not limited to the above range.

A thickness of the polyamideimide film according to one embodiment may be 30 μm to 80 μm, 40 μm to 80 μm, 40 μm to 60 μm, or 50 μm to 80 μm, and an absolute value of a thickness direction retardation of the polyamideimide film according to one embodiment may be 200 nm to 600 nm, 200 nm to 500 nm, 250 nm to 600 nm, 250 nm to 550 nm, 300 nm to 600 nm, or 300 nm to 500 nm when measured at a wavelength of 550 nm. However, the thickness and the absolute value of the thickness direction retardation are not limited to the above ranges. The thickness direction retardation value may be measured at a normal temperature before heating the film, and the normal temperature may be a temperature in a state in which the temperature is not artificially controlled. For example, the normal temperature may be 20° C. to 40° C., 20° C. to 30° C., or 23° C. to 26° C.

A modulus of the polyamideimide film according to one embodiment may be 4.0 GPa or more, 4.0 GPa or more and 5.0 GPa or less, 4.0 GPa or more and 4.5 GPa or less, or 4.1 GPa or more and 4.7 GPa or less when measured according to ASTM E111. The polyamideimide film according to one embodiment may satisfy both the modulus and the elongation at break, and thus may provide sufficient mechanical properties and durability to be applied to a cover window for a display device.

The polyamideimide film according to one embodiment satisfies the thickness direction retardation, the yellow index, the modulus, and/or the elongation at break within the above range, and thus may have further improved visibility by preventing an image distortion due to light. In addition, the polyamideimide film may exhibit more uniform mechanical properties (a modulus and the like) and optical properties (a thickness direction retardation and the like) in the entire central portion and edge portion thereof, and may further reduce a film loss. In addition, since the polyamideimide film is flexible and has excellent bending properties, and the polyamideimide film may prevent a deformation and/or damage to the film even when a predetermined deformation occurs repeatedly, and may be more easily restored to the original shape. In addition, a cover window including the polyamideimide film according to one embodiment may have more excellent visibility and may prevent folded marks and micro-cracks, and thus may impart more excellent durability and long-term life to a foldable display device or a flexible display device.

The diacid dichloride-derived structural unit included in the polyamideimide film according to one embodiment may be included in an amount of 5 mol % to 50 mol % with respect to a content of 100 mol % of the diamine-derived structural unit. Alternatively, the diacid dichloride-derived structural unit may be included in an amount of 10 mol % to 50 mol %, 10 mol % to 40 mol %, 5 mol % to 40 mol %, or 20 mol % to 40 mol %, with respect to 100 mol % of the diamine-derived structural unit. In this case, specifically, the diacid dichloride-derived structural unit may be a structural unit derived from any one of a compound represented by Chemical Formula 3 and a compound represented by Chemical Formula 4, and the diamine-derived structural unit may be a structural unit derived from a compound represented by Chemical Formula 1. The polyamideimide film according to one embodiment includes the diacid dichloride-derived structural unit in an amount within the above range with respect to 100 mol % of the diamine-derived structural unit, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

A molar ratio of the dianhydride-derived structural unit and the diacid dichloride-derived structural unit included in the polyamideimide film according to one embodiment may be 95:5 to 50:50. Alternatively, the molar ratio of the dianhydride-derived structural unit and the diacid dichloride-derived structural unit may be, for example, 90:10 to 50:50, 90:10 to 60:40, 95:5 to 60:40, or 80:20 to 60:40. In this case, specifically, the dianhydride-derived structural unit may be a structural unit derived from a compound represented by Chemical Formula 2, and the diacid dichloride-derived structural unit may be a structural unit derived from any one of a compound represented by Chemical Formula 3 and a compound represented by Chemical Formula 4. The polyamideimide film according to one embodiment includes the dianhydride-derived structural unit and the diacid dichloride-derived structural unit at the above molar ratio, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

In addition, as the diamine, one or a mixture of two or more selected from p-phenylenediamine (p-PDA), m-phenylenediamine (m-PDA), 4,4′-oxydianiline (4,4′-ODA), 3,4′-oxydianiline (3,4′-ODA), 2,2-bis[4-(4-aminophenoxy)phenyl]propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis[4-(4-aminophenoxy)phenyl]sulfone (BAPS), 2,2-bis[4-(3-aminophenoxy)phenyl]sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bis(trifluoromethyl)benzidine (TFMB), 1,4-bis(4-amino-2-trifluoromethylphenoxy)benzene (6FAPB), 2,2′-bis(trifluoromethyl)-4,4′-diaminodiphenyl ether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, and 5-amino-2-(4-aminophenyl)benzoxazole may be used, if necessary, but is not limited thereto.

In addition, the dianhydride may further include pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2′-bis-(3, 4-dicarboxyphenyl)hexafluoropropane dianhydride (6FDA), p-phenylene bistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), or a combination thereof, if necessary.

In addition, the diacid dichloride may further include [1,1′-biphenyl]-4,4′-dicarbonyl dichloride (BPC), 1,4-naphthalenedicarboxylic acid dichloride (NPC), 2,6-naphthalenedicarboxylic acid dichloride (NTC), 1,5-naphthalenedicarboxylic acid dichloride (NEC), or a combination thereof, if necessary.

The polyamideimide film according to one embodiment may be produced using a polyamideimide resin including the diamine-derived structural unit, the dianhydride-derived structural unit, and the diacid dichloride-derived structural unit described above. In this case, the polyamideimide resin may have a weight average molecular weight (Mw) of 10,000 g/mol to 80,000 g/mol, 10,000 g/mol to 7,000 g/mol, or 10,000 g/mol to 6,000 g/mol, but is not limited thereto.

Hereinafter, a method of producing a polyamideimide film according to one embodiment will be described.

The polyamideimide film according to one embodiment may be produced by a method including: step i) preparing a diamine solution by mixing a diamine containing a compound represented by the following Chemical Formula 1 with a solvent; step ii) preparing a polyamideimide precursor by reacting a dianhydride containing a compound represented by the following Chemical Formula 2 with a diacid dichloride containing any one of a compound represented by the following Chemical Formula 3 and a compound represented by the following Chemical Formula 4 in the diamine solution; and step iii) performing a heat treatment after applying the polyamideimide precursor to a substrate:

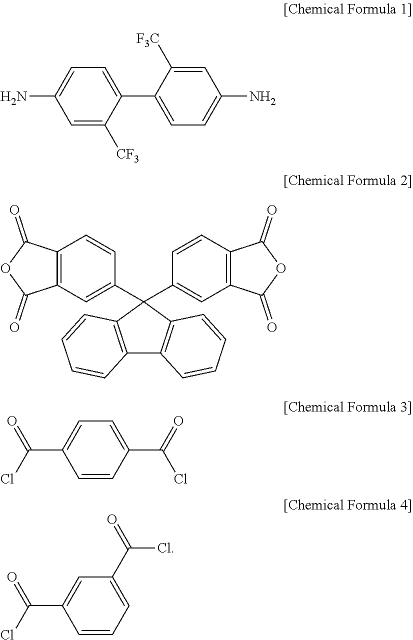

In the method of producing a polyamideimide film according to one embodiment, the diacid dichloride may be used in an amount of 5 mol % to 50 mol % with respect to 100 mol % of the diamine. Alternatively, the diacid dichloride may be used in an amount of 10 mol % to 50 mol o, 10 mol % to 40 mol o, 5 mol % to 40 mol o, or 20 mol % to 40 mol o, with respect to 100 mol % of the diamine. In this case, specifically, the diacid dichloride may be any one of a compound represented by Chemical Formula 3 and a compound represented by Chemical Formula 4, and the diamine may be a compound represented by Chemical Formula 1. In the method of producing a polyamideimide film according to one embodiment, the diacid dichloride is used in an amount within the above range, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

In the method of producing a polyamideimide film according to one embodiment, a molar ratio of the dianhydride and the diacid dichloride may be 95:5 to 50:50. Alternatively, the molar ratio of the dianhydride and the diacid dichloride may be, for example, 90:10 to 50:50, 90:10 to 60:40, 95:5 to 60:40, or 80:20 to 60:40. In this case, specifically, the dianhydride may be a compound represented by Chemical Formula 2, and the diacid dichloride may be any one of a compound represented by Chemical Formula 3 and a compound represented by Chemical Formula 4. In the method of producing a polyamideimide film according to one embodiment, the dianhydride and the diacid dichloride are contained at the above molar ratio, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

In the method of producing a polyamideimide film according to one embodiment, the polyamideimide precursor in a solution state may contain a solid in an amount of 5 wt % to 40 wt % 10 wt % to 40 wt %, 10 wt % to 30 wt %, or 10 wt % to 20 wt %, with respect to the total weight of the solution, and the remainder may be an organic solvent. The polyamideimide precursor has a low viscosity even when the solid content is within the above range, and thus may provide advantages in a process. In general, since mechanical properties such as the absolute value of the thickness direction retardation and the modulus have a trade-off relationship with each other, it is difficult to simultaneously improve these properties, but the polyamideimide film according to one embodiment may simultaneously improve these properties.

In the method of producing a polyamideimide film according to one embodiment, step i) may be performed in an organic solvent, a polar solvent, specifically, in an amide-based solvent. The amide-based solvent may refer to a compound having an amide moiety. The amide-based solvent may be an aromatic or aliphatic solvent, and may be, for example, an aliphatic solvent. In addition, the amide-based solvent may be, for example, a cyclic compound or a chain compound. Specifically, the amide-based solvent may have 2 to 15 carbon atoms, and may have, for example, 3 to 10 carbon atoms. The amide-based solvent may have an N,N-dialkylamide moiety. Dialkyl groups may be each independently present or may be fused with each other to form a ring, or at least one alkyl group in the dialkyl group may be fused with another substituent in the molecule to form a ring. For example, at least one alkyl group in the dialkyl group may be fused with an alkyl group linked to a carbonyl carbon of the amide moiety to form a ring. In this case, the ring may be a 4- to 7-membered ring, and may be, for example, a 5- to 7-membered ring or a 5- or 6-membered ring. The alkyl group may be, for example, a C₁₋₁₀ alkyl group or a C₁₋₈ alkyl group, and may be, for example, methyl, ethyl, or the like. More specifically, the amide-based solvent is not limited as long as it is generally used in polymerization of polyamic acid and/or polyamideimide, and examples thereof include dimethylpropionamide, diethylpropionamide, dimethylacetylamide, diethylacetamide, dimethylformamide, methylpyrrolidone, ethylpyrrolidone, octylpyrrolidone, and a combination thereof. Specifically, the amide-based solvent may contain dimethylpropionamide.

In the method of producing a polyamideimide film according to one embodiment, step iii) is a thermal curing step. Specifically, in the method of producing a polyamideimide film according to one embodiment, the heat treatment in the performing of the heat treatment may be performed at 300° C. to 350° C. or 280° C. to 350° C. for 10 minutes to 60 minutes. In a case where the curing is performed at a relatively low temperature, the film has a reduced thermal history, and thus, the yellow index tends to be relatively lowered, but in a case where the curing is performed at a temperature lower than a glass transition temperature (Tg), the thickness direction retardation may be increased due to an orientation of a molecular structure. The polyamideimide film according to one embodiment is subjected to the heat treatment at 300° C. to 350° C. or 280° C. to 350° C., such that polymer chains are more isotropically arranged, which may reduce the thickness direction retardation. In addition, the heat treatment may be performed for, for example, 10 minutes to 50 minutes, 10 minutes to 40 minutes, 10 minutes to 30 minutes, or 10 minutes to 20 minutes, but is not limited thereto. In addition, the thermal curing may be performed, for example, in a separate vacuum oven or an oven filled with an inert gas.

In addition, before the performing of the heat treatment, a drying step may be additionally performed, if necessary. The drying step may be performed at 50° C. to 150° C., 50° C. to 130° C., 60° C. to 100° C., or about 80° C., but is not limited to the above range.

The method of producing a polyamideimide film according to one embodiment may further include, after the applying of the polyamideimide precursor to the substrate, allowing the polyamideimide precursor to stand at normal temperature, if necessary. Optical properties of a surface of the film may be further stably maintained by the allowing of the polyamideimide precursor to stand. While not wishing to be bound by a certain theory, when a polyamideimide film-forming composition according to the related art is allowed to stand before being cured, a solvent absorbs moisture in the air, the moisture diffuses inside the solvent, and the moisture collides with polyamic acid and/or polyamideimide, which causes whitening from a surface of a film and cissing, and as a result, coating unevenness may occur. On the other hand, the polyamideimide precursor according to one embodiment does not cause whitening and cissing even when allowed to stand in the air for a long time, and may realize the advantage of being able to secure a film having improved optical properties. The allowing of the polyamideimide precursor to stand may be performed under normal temperature and/or high humidity conditions. In this case, the normal temperature may be 40° C. or lower, 30° C. or lower, or 25° C. or lower, more specifically may be 15° C. to 25° C., and particularly preferably, may be 20° C. to 25° C. In addition, the high humidity may be a relative humidity of 50% or more, 60% or more, 70% or more, or 80% or more. The allowing of the polyamideimide precursor to stand may be performed for 1 minute to 3 hours, 10 minutes to 2 hours, or 20 minutes to 1 hour.

In the method of producing a polyamideimide film according to one embodiment, the polyamideimide film may be produced by mixing the polyamic acid solution with one or two or more additives selected from a retardant, an adhesion enhancer, inorganic particles, an antioxidant, an ultraviolet inhibitor, and a plasticizer.

In addition, in the method of producing a polyamideimide film according to one embodiment, as a method for the application for forming the polyamideimide film, any method may be used without limitation as long as it is commonly used in the art. Non-limiting examples thereof include a knife coating method, a dip coating method, a roll coating method, a slot die coating method, a lip die coating method, a slide coating method, and a curtain coating method, and the same or different methods may be sequentially applied one or more times.

The substrate may be used without limitation as long as it is commonly used in the art, and as a non-limiting example thereof, glass; stainless steel; or a plastic film formed of polyethylene terephthalate, polyethylene naphthalate, polypropylene, polyethylene, cellulose triacetate, cellulose diacetate, poly(meth)acrylic acid alkyl ester, a poly(meth)acrylic acid ester copolymer, polyvinyl chloride, polyvinyl alcohol, polycarbonate, polystyrene, cellophane, a polyvinylidene chloride copolymer, polyamide, polyimide, a vinyl chloride-vinyl acetate copolymer, polytetrafluoroethylene, or polytrifluoroethylene may be used.

Hereinafter, a polyamideimide film-forming composition according to one embodiment will be described.

A composition for forming a polyamideimide film (hereinafter, referred to as a polyamideimide film-forming composition) according to one embodiment may contain: polyamic acid or polyamideimide including a diamine-derived structural unit, a dianhydride-derived structural unit, and a diacid dichloride-derived structural unit; and

a mixed solvent including an amide-based solvent and a hydrocarbon-based solvent,

wherein the diamine-derived structural unit includes a structural unit derived from a compound represented by the following Chemical Formula 1, the dianhydride-derived structural unit includes a structural unit derived from a compound represented by the following Chemical Formula 2, and the diacid dichloride-derived structural unit includes a structural unit derived from any one of a compound represented by the following Chemical Formula 3 and a compound represented by the following Chemical Formula 4.

The polyamideimide film-forming composition according to one embodiment may inhibit an interaction between the polyamic acid and the mixed solvent and thus may significantly reduce an intermolecular packing density during curing, such that it is possible to provide a polyamideimide film that may prevent deterioration of colorless and transparent performance and simultaneously implement excellent optical properties and excellent heat resistance. In addition, a viscosity of the polyamideimide film-forming composition according to one embodiment may be significantly reduced by using a mixed solvent including an amide-based solvent and a hydrocarbon-based solvent even when the composition contains a high solid content, such that the polyamideimide film-forming composition may be applied to a thin film coating process with a high solid content and a low viscosity, and may affectively implement desired physical properties.

In addition, the polyamideimide film-forming composition according to one embodiment may satisfy the following Expression 1. While not wishing to be bound by a certain theory, the polyamideimide film-forming composition satisfying such a condition may be advantageously applied to a thin film process when forming a film, may inhibit a packing density of a polyamideimide film, and may render the polyamideimide film amorphous, resulting in improvement of the optical properties.

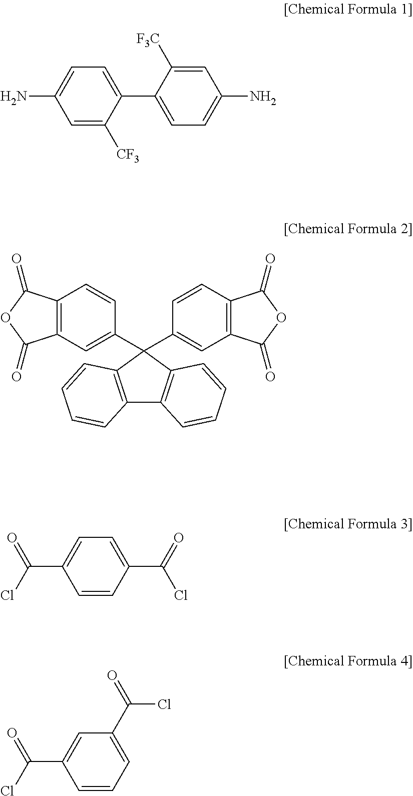 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

5,000 ≤V_{PAI} ≤15,000 [Expression 1]

wherein

V_{PAI} is a viscosity of the polyamideimide film-forming composition when a solid content is 17 wt % with respect to the total weight of the polyamideimide film-forming composition, and the viscosity is a viscosity (unit: cp) measured at 25° C. with a Brookfield rotational viscometer using a 52Z spindle based on a torque of 80% and a time of 2 minutes.

The viscosity (V_{PAI}) of the polyamideimide film-forming composition according to one embodiment may be 5,000 cp to 13,000 cp, 6,000 cp to 13,000 cp, 15,000 cp or less, 13,000 cp or less, 11,000 cp or less, or 10,000 cp or less. Therefore, the polyamideimide film-forming composition containing a high solid content may be more easily applied to a thin film process, and may provide a polyamideimide film having further excellent colorless and transparent performance, optical properties, and heat resistance. In this case, the solid may be the polyamic acid and/or the polyamideimide.

In the polyamideimide film-forming composition according to one embodiment, the solvent condition is changed, specifically, a non-polar solvent having almost no affinity with polyamideimide is applied without using a polymerization solvent of polyamic acid (hereinafter, referred to as a polyamideimide precursor) and/or polyamideimide, such that optical properties and heat resistance of a polyamideimide film may be simultaneously improved. Specifically, the polyamideimide film-forming composition according to one embodiment may contain polyamic acid and/or polyamideimide, a polar solvent, and a non-polar solvent. The polar solvent may be a hydrophilic solvent, may have affinity with, for example, polyamic acid and/or polyamideimide, and may be, for example, an amide-based solvent. In addition, the non-polar solvent may have almost no affinity with polyamic acid and/or polyamideimide, and may be, for example, a hydrocarbon-based solvent.

A mixed solvent including an amide-based solvent and a hydrocarbon-based solvent is used in the polyamideimide film-forming composition according to one embodiment, such that an intermolecular interaction between polymers and/or an interaction between a polymer and a solvent may be effectively inhibited, and an intermolecular packing density during curing may be significantly reduced, and as a result, optical properties and mechanical properties may be simultaneously improved. Furthermore, the mixed solvent is used, such that the polyamideimide film-forming composition may have a low viscosity while having a high solid content. Therefore, the polyamideimide film-forming composition according to one embodiment has a low viscosity while having a high solid content, such that a thin film may be more easily formed by a solution process, and it is possible to provide a polyamideimide film that prevents deterioration of mechanical properties and heat resistance and has an excellent yellow index.

In the polyamideimide film-forming composition according to one embodiment, the amide-based solvent refers to a compound having an amide moiety. The amide-based solvent may be a cyclic compound or a chain compound, and specifically, may be a chain compound. Specifically, the chain compound may have 2 to 15 carbon atoms, and more specifically, may have 3 to 10 carbon atoms. The amide-based solvent may have an N,N-dialkylamide moiety. Dialkyl groups may be each independently present or may be fused with each other to form a ring, or at least one alkyl group in the dialkyl group may be fused with another substituent in the molecule to form a ring. For example, at least one alkyl group in the dialkyl group may be fused with an alkyl group linked to a carbonyl carbon of the amide moiety to form a ring. In this case, the ring may be a 4- to 7-membered ring, and may be, for example, a 5- to 7-membered ring or a 5- or 6-membered ring. The alkyl group may be, for example, a C₁₋₁₀ alkyl group or a C₁₋₈ alkyl group, and may be, for example, methyl, ethyl, or the like. More specifically, the amide-based solvent is not limited as long as it is generally used in polymerization of polyamic acid, and examples thereof include dimethylpropionamide, diethylpropionamide, dimethylacetylamide, diethylacetamide, dimethylformamide, methylpyrrolidone, ethylpyrrolidone, octylpyrrolidone, and a combination thereof. Specifically, the amide-based solvent may contain dimethylpropionamide.

In the polyamideimide film-forming composition according to one embodiment, the hydrocarbon-based solvent may be a non-polar solvent as described above. The hydrocarbon-based solvent may be a compound composed of carbon and hydrogen. The hydrocarbon-based solvent may be, for example, an aromatic or aliphatic solvent. The hydrocarbon-based solvent may be, for example, a cyclic compound or a chain compound, and specifically may be a cyclic compound. Here, in a case where the hydrocarbon-based solvent is a cyclic compound, the hydrocarbon-based solvent may have a single ring or a polycyclic ring, and the polycyclic ring may be a fused ring or a non-fused ring, and specifically may be a single ring. The hydrocarbon-based solvent may have, for example, 3 to 15 carbon atoms, 6 to 15 carbon atoms, or 6 to 12 carbon atoms. The hydrocarbon-based solvent may be a substituted or unsubstituted C₃₋₁₅ cycloalkane, a substituted or unsubstituted C₆₋₁₅ aromatic compound, or a combination thereof. In this case, the cycloalkane may include cyclobutane, cyclopentane, cyclohexane, cycloheptane, cyclooctane, or a combination thereof, and the aromatic compound may include benzene, naphthalene, or a combination thereof. The hydrocarbon-based solvent may be a cycloalkane substituted or unsubstituted with at least one C₁₋₅ alkyl group, an aromatic compound substituted or unsubstituted with at least one C₁₋₅ alkyl group, or a combination thereof. In this case, each of the cycloalkane and the aromatic compound is as described above. The C₁₋₅ alkyl group may be, for example, a C₁₋₃ alkyl group or a C₁₋₂ alkyl group, and more specifically may be a methyl group, but is not limited thereto. In addition, the hydrocarbon-based solvent may further contain oxygen, if necessary. For example, in a case where the hydrocarbon-based solvent contains oxygen, the hydrocarbon-based solvent may contain a ketone group or a hydroxy group, and the hydrocarbon-based solvent may be cyclopentanone, cresol, or a combination thereof. Specifically, the hydrocarbon-based solvent may include benzene, toluene, cyclohexane, cyclopentanone, cresol, or a combination thereof, but is not limited thereto.

More specifically, the polyamideimide film-forming composition according to one embodiment may contain a mixed solvent including an amide-based solvent containing dimethylpropionamide and a hydrocarbon-based solvent selected from toluene, benzene, and cyclohexane.

The hydrocarbon-based solvent according to one embodiment may be added after polymerization of polyamic acid or polyamideimide.

Therefore, in the polyamideimide film-forming composition according to one embodiment, an intermolecular behavior and an interaction may be different from those in simple addition of a mixed solution in the polymerization of polyamic acid. For example, in a case where the hydrocarbon-based solvent is mixed in the polymerization of polyamic acid, the hydrocarbon-based solvent may act as a factor inhibiting polymerization. Therefore, polyamic acid having a high molecular weight may not be obtained. On the other hand, in the polyamideimide film-forming composition according to one embodiment, after obtaining polyamic acid and/or polyamideimide having a sufficiently high molecular weight, the hydrocarbon-based solvent is mixed, such that the hydrocarbon-based solvent may act as a catalyst to weaken an intermolecular interaction between polymers and/or a strong interaction between a polymer and a solvent, and desired optical properties may be obtained in subsequent curing. In this case, the amide-based solvent and the hydrocarbon-based solvent are sequentially used, such that an interaction between the polyamic acid that is a polyamideimide precursor and the solvent may be controlled in a more appropriate range. In this case, the control may refer to inhibition.

The polyamideimide film-forming composition according to one embodiment may contain the amide-based solvent and the hydrocarbon-based solvent at a weight ratio of 8:2 to 5:5, and specifically, at a weight ratio of 7.5:2.5 to 5:5 or 7.5:2.5 to 5.5:4.5. The polyamideimide film-forming composition contains the amide-based solvent and the hydrocarbon-based solvent at the above weight ratio, such that further excellent optical properties may be implemented and excellent reactivity of diamine and dianhydride may be maintained, an intermolecular packing density may be appropriately inhibited during curing the polyamideimide film-forming composition, and the polyamideimide film-forming composition may be amorphous. Therefore, it is possible to provide a polyamideimide film that prevents deterioration of heat resistance and mechanical properties and has a further improved yellow index.

The diacid dichloride-derived structural unit included in the polyamideimide film-forming composition according to one embodiment may be included in an amount of 5 mol % to 50 mol % with respect to a content of 100 mol % of the diamine-derived structural unit. Alternatively, the diacid dichloride-derived structural unit may be included in an amount of 10 mol % to 50 mol %, 10 mol % to 40 mol %, 5 mol % to 40 mol %, or 20 mol % to 40 mol %, with respect to the content of 100 mol % of the diamine-derived structural unit. In this case, specifically, the diacid dichloride-derived structural unit may be a structural unit derived from any one of a compound represented by Chemical Formula 3 and a compound represented by Chemical Formula 4, and the diamine-derived structural unit may be a structural unit derived from a compound represented by Chemical Formula 1. The polyamideimide film-forming composition according to one embodiment includes the diacid dichloride-derived structural unit in an amount within the above range with respect to 100 mol % of the diamine-derived structural unit, such that it is possible to produce a polyamideimide film that is more transparent and has a low thickness direction retardation and excellent mechanical properties such as a high modulus using the polyamideimide film-forming composition. Therefore, the polyamideimide film may implement optical properties and mechanical properties equivalent to or superior to those of tempered glass.

A molar ratio of the dianhydride-derived structural unit and the diacid dichloride-derived structural unit included in the polyamideimide film-forming composition according to one embodiment may be 95:5 to 50:50. Alternatively, the molar ratio of the dianhydride-derived structural unit and the diacid dichloride-derived structural unit may be, for example, 90:10 to 50:50, 90:10 to 60:40, 95:5 to 60:40, or 80:20 to 60:40. In this case, specifically, the dianhydride-derived structural unit may be a structural unit derived from a compound represented by Chemical Formula 2, and the diacid dichloride-derived structural unit may be a structural unit derived from any one of a compound represented by Chemical Formula 3 and a compound represented by Chemical Formula 4. The polyamideimide film-forming composition according to one embodiment includes the dianhydride-derived structural unit and the diacid dichloride-derived structural unit at the above molar ratio, such that it is possible to produce a polyamideimide film that is more transparent and has a low thickness direction retardation and excellent mechanical properties such as a high modulus using the polyamideimide film-forming composition. Therefore, the polyamideimide film may implement optical properties and mechanical properties equivalent to or superior to those of tempered glass.

In addition, as the diamine, one or a mixture of two or more selected from p-phenylenediamine (p-PDA), m-phenylenediamine (m-PDA), 4,4′-oxydianiline (4,4′-ODA), 3,4′-oxydianiline (3,4′-ODA), 2,2-bis[4-(4-aminophenoxy)phenyl]propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis[4-(4-aminophenoxy)phenyl]sulfone (BAPS), 2,2-bis[4-(3-aminophenoxy)phenyl]sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bis(trifluoromethyl)benzidine (TFMB), 1,4-bis(4-amino-2-trifluoromethylphenoxy)benzene (6FAPB), 2,2′-bis(trifluoromethyl)-4,4′-diaminodiphenyl ether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, and 5-amino-2-(4-aminophenyl)benzoxazole may be used, if necessary, but is not limited thereto.

In addition, the dianhydride may further include pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxyphenyl)hexafluoropropane dianhydride (6FDA), p-phenylene bistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), or a combination thereof, if necessary.

In addition, the diacid dichloride may further include [1,1′-biphenyl]-4,4′-dicarbonyl dichloride (BPC), 1,4-naphthalenedicarboxylic acid dichloride (NPC), 2,6-naphthalenedicarboxylic acid dichloride (NTC), 1,5-naphthalenedicarboxylic acid dichloride (NEC), or a combination thereof, if necessary.

The polyamideimide film-forming composition according to one embodiment contains the polyamic acid and/or the polyamideimide including the diamine-derived structural unit, the dianhydride-derived structural unit, and the diacid dichloride-derived structural unit described above. A weight average molecular weight (Mw) of the polyamic acid and/or the polyamideimide is not particularly limited, and may be 10,000 g/mol or more, specifically, 20,000 g/mol or more, and more specifically, 25,000 g/mol to 80,000 g/mol. The polyamic acid and/or the polyamideimide has a weight average molecular weight within the above range, such that it is possible to provide a film that has more excellent optical properties and mechanical properties and prevents curling.

A solid content in the polyamideimide film-forming composition according to one embodiment may be 40 wt % or less, 10 wt % to 40 wt %, 35 wt % or less, 30 wt % or less, 10 wt % to 25 wt %, or 15 wt % to 25 wt %, with respect to the total weight of the polyamideimide film-forming composition. In this case, the solid may be the polyamic acid or the polyamideimide.

In general, a viscosity of the polyamideimide tends to be increased as a concentration of the solid is increased, and for example, in a case where the polyamic acid and/or the polyamideimide is dissolved in a general amide-based solvent alone, a viscosity of the solution is as high as about 15,000 cp or more. In this case, the viscosity of the solution refers to a viscosity when the solid content is 17 wt % with respect to the total weight of the solution. In a case where a thin film is produced by a solution process, for example, a coating process, when the polymer does not flow smoothly due to a high viscosity, it is difficult to remove air bubbles and a mura may occur during coating. On the other hand, in the polyamideimide film-forming composition according to one embodiment, the mixed solvent including an amide-based solvent and a hydrocarbon-based solvent is used, such that the viscosity of the composition may be significantly reduced even when the composition has a high solid content of 17 wt % or more. Therefore, it is possible to effectively prevent defects occurring during a solution process, for example, a coating process, and thus further improved optical properties may be implemented. In addition, the polyamideimide film-forming composition may be commercially advantageous because it has a high solid content without defects occurring during the coating process.

Hereinafter, a method of preparing a polyamideimide film-forming composition according to one embodiment will be described.

The polyamideimide film-forming composition according to one embodiment may be prepared by a method including: preparing a polyamic acid solution by reacting a diamine containing a compound represented by the following Chemical Formula 1, a dianhydride containing a compound represented by the following Chemical Formula 2, and a diacid dichloride containing any one of a compound represented by the following Chemical Formula 3 and a compound represented by the following Chemical Formula 4 with each other in an amide-based solvent (step i); and

adjusting a viscosity by adding a hydrocarbon-based solvent to satisfy Expression 1 (step ii):

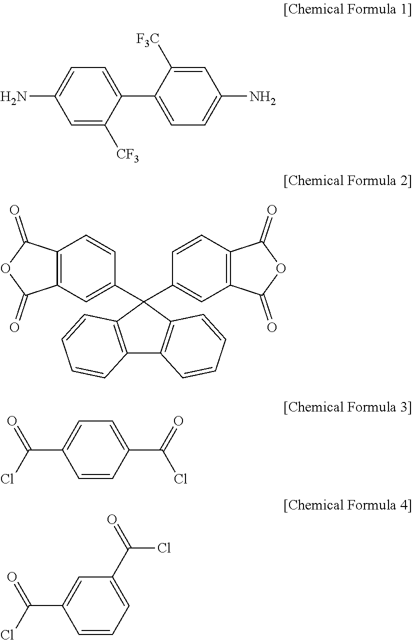

5,000 ≤V_{PAI} ≤15,000 [Expression 1]

wherein

V_{PAI} is a viscosity of the polyamideimide film-forming composition when a solid content is 17 wt % with respect to the total weight of the polyamideimide film-forming composition, and the viscosity is a viscosity (unit: cp) measured at 25° C. with a Brookfield rotational viscometer using a 52Z spindle based on a torque of 80% and a time of 2 minutes.

Step i according to one embodiment is a step of polymerizing polyamic acid by mixing a diamine, a dianhydride, and a diacid dichloride with each other, and may include a step of dissolving the diamine in an amide-based solvent, a step of adding and dissolving the diacid dichloride, a step of adding and dissolving the dianhydride, and a step of reacting the reaction solution by stirring the reaction solution for 5 to 7 hours.

Step ii according to one embodiment may be a step of additionally adding the hydrocarbon-based solvent described above and stirring the mixture and then additionally adding a mixed solvent including an amide-based solvent and a hydrocarbon-based solvent, and a viscosity range of the polyamideimide film-forming composition may satisfy Expression 1 by step ii. Specifically, step ii includes a step of additionally adding a hydrocarbon-based solvent in an amount of 25 wt % to 100 wt % or 25 wt % to 50 wt % with respect to the weight of the amide-based solvent in step i at normal temperature (25° C.) and stirring the mixture for 15 hours to 20 hours; and a step of adding a mixed solvent including an amide-based solvent and a hydrocarbon-based solvent to satisfy Expression 1 after completing the stirring of the mixture. While not wishing to be bound by a certain theory, the polyamideimide film-forming composition satisfying such a condition may inhibit a packing density of a polyamideimide film and may render the polyamideimide film amorphous during curing. Therefore, it is possible to provide a polyamideimide film that prevents deterioration of mechanical properties and heat resistance and has a further improved yellow index.

In addition, in the polyamideimide film-forming composition according to one embodiment, an intermolecular behavior and an interaction may be different from those in simple addition of a mixed solution in a polymerization process of polyamic acid. For example, in a case where the hydrocarbon-based solvent is included in the step of polymerizing polyamic acid, the hydrocarbon-based solvent may act as a factor inhibiting polymerization. Therefore, polyamic acid having a high molecular weight may not be obtained. On the other hand, in the polyamideimide film-forming composition according to one embodiment, the hydrocarbon-based solvent is mixed after obtaining a sufficiently high molecular weight of polyamic acid and/or polyamideimide, such that a high molecular weight of polyamic acid may be obtained. In addition, the hydrocarbon-based solvent may act as a catalyst to weaken an intermolecular interaction between polymers and/or a strong interaction between a polymer and a solvent, and desired optical properties may be obtained in subsequent curing.

In the method of preparing a polyamideimide film-forming composition according to one embodiment, the diacid dichloride may be used in an amount of 5 mol % to 50 mol % with respect to 100 mol % of the diamine. Alternatively, the diacid dichloride may be used in an amount of 10 mol % to 50 mol %, 10 mol % to 40 mol %, 5 mol % to 40 mol %, or 20 mol % to 40 mol %, with respect to 100 mol % of the diamine. In this case, specifically, the diacid dichloride may be any one of a compound represented by Chemical Formula 3 and a compound represented by Chemical Formula 4, and the diamine may be a compound represented by Chemical Formula 1. In the method of preparing a polyamideimide film-forming composition according to one embodiment, the diacid dichloride is contained in an amount within the above range, such that it is possible to prepare a composition for producing a polyamideimide film that may be more transparent and have a low thickness direction retardation and excellent mechanical properties such as a high modulus and elongation at break. Therefore, the polyamideimide film may implement optical properties and mechanical properties equivalent to or superior to those of tempered glass.

In the method of preparing a polyamideimide film-forming composition according to one embodiment, a molar ratio of the dianhydride and the diacid dichloride may be 95:5 to 50:50. Alternatively, the molar ratio of the dianhydride and the diacid dichloride may be, for example, 90:10 to 50:50, 90:10 to 60:40, 95:5 to 60:40, or 80:20 to 60:40. In this case, specifically, the dianhydride may be a compound represented by Chemical Formula 2, and the diacid dichloride may be any one of a compound represented by Chemical Formula 3 and a compound represented by Chemical Formula 4. In the method of preparing a polyamideimide film-forming composition according to one embodiment, the dianhydride and the diacid dichloride are contained at the above molar ratio, such that a polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

The polyamideimide film according to one embodiment may be obtained by curing the polyamideimide film-forming composition according to any one of the embodiments.

The polyamideimide film includes the structural units derived from the compounds represented by Chemical Formulas 1 and 2, and any one of a compound represented by Chemical Formula 3 and a compound represented by Chemical Formula 4, such that a distortion due to light may be further prevented in comparison to a polyamideimide film containing a polyamideimide polymer having a rigid structure. For example, in the polyamideimide film according to one embodiment, the dianhydride-derived structural unit may not include a rigid structural unit. For example, the dianhydride-derived structural unit may not include a structural unit derived from a dianhydride in which two anhydride groups are fused to one ring. The ring may be a single ring or a fused ring, and may be an aromatic ring, an aliphatic ring, or a combination thereof. Specifically, the dianhydride-derived structural unit may not include a structural unit derived from pyromellitic dianhydride (PMDA), a structural unit derived from cyclobutane-1,2,3,4-tetracarboxylic dianhydride (CBDA), or a combination thereof.

Accordingly, the polyamideimide film according to one embodiment may implement a low thickness direction retardation and may further improve visibility while being transparent at a thickness of 30 μm or more, such that a cover window including the polyamideimide film may further reduce eye fatigue of a user. In addition, the polyamideimide film may have further improved mechanical strength such as a modulus as well as excellent optical properties even at a thickness of 30 μm or more as described above, and thus may have further improved dynamic bending properties. Therefore, the polyamideimide film may be suitable for a use as a cover window of a foldable display device or a flexible display device that repeatedly folds and unfolds.

Hereinafter, a use of the polyamideimide film according to one embodiment will be described.

An aspect according to one embodiment may be a multi-layered structure including the polyamideimide film according to one embodiment. For example, the multi-layered structure may be a cover window for a display device including: the polyamideimide film; and a coating layer disposed on the polyamideimide film. In addition, the multi-layered structure may include a polyamideimide film containing monomers having compositions different from those of the polyamideimide film according to one embodiment, and two or more coating layers.

In this case, non-limiting examples of the coating layer include a hard coating layer, an antistatic layer, an anti-fingerprint layer, an anti-fouling layer, an anti-scratch layer, a low-refractive layer, an anti-reflective layer, an impact absorption layer, and a combination thereof, but are not limited thereto. In this case, a thickness of the coating layer may be 1 μm to 500 μm, 2 μm to 450 μm, or 2 μm to 200 μm, but is not limited thereto.

In addition, the multi-layered structure according to one embodiment may include the polyamideimide film according to one embodiment and a semiconductor layer that are formed on a substrate. Non-limiting examples of a material of the semiconductor layer include low-temperature polysilicon (LIPS), low-temperature polyoxide (LTPO), indium tin oxide (ITO), and indium gallium zinc oxide (IGZO), and the semiconductor layer may contain, for example, LIPS and/or LTPO. In a case of a display device obtained using low-temperature polysilicon (LIPS) and/or low-temperature polycrystalline oxide (LTPO), a process temperature may be close to 350° C. or higher and 500° C. or lower. In such a high-temperature process, even polyamideimide having excellent heat resistance is easily thermally decomposed by hydrolysis. Therefore, in order to manufacture an LIPS and/or LTPO flexible device, there is a need for a material having excellent heat resistance in which thermal decomposition by hydrolysis does not occur even in a high-temperature process. The polyamideimide film according to one embodiment has excellent optical properties and heat resistance at the same time, and thus may be utilized in an LIPS and/or LTPO display device.

Another aspect may be a display device including the polyamideimide film according to one embodiment.

As described above, the polyamideimide film according to one embodiment has excellent optical properties and mechanical properties, and specifically, may exhibit a sufficient retardation at various angles, and thus may be applied in various industrial fields requiring a wide viewing angle.

As an example, the display device is not particularly limited as long as it belongs to a field requiring excellent optical properties, and may be provided by selecting a display panel appropriate therefor. Specifically, the display device may be applied to a flexible display device, and non-limiting examples thereof include, but are not limited to, various image display devices such as a liquid crystal display device, an electroluminescence display device, a plasma display device, and a field emission display device.

In addition, in the case of the display device including the polyamideimide film according to one embodiment, display quality may be excellent, in particular, a rainbow phenomenon in which iridescent stains occur may be significantly prevented because a distortion caused by light is significantly reduced, and it is possible to minimize the user's eye fatigue because visibility is excellent. In particular, in accordance with an increase in size of a screen of a display device, the screen has been often viewed from the side. In a case where the polyamideimide film for a cover window according to one embodiment is applied to the display device, the display device has excellent visibility even when viewed from the side. Therefore, the polyamideimide film may be usefully applied to a large display device.

Hereinafter, Examples and Experimental Examples will be described in detail below. However, Examples and Experimental Examples described below are merely illustrative of one embodiment, but one embodiment is not limited thereto.

Physical properties were measured as follows.

<Measurement Methods>

1. Viscosity (V_{PAI})

In order to measure a viscosity, 0.5 μl of a polyamideimide film-forming composition (a concentration of a solid of 17 wt %) was put in a container, a spindle was lowered, an rpm was adjusted, after waiting for 2 minutes when a torque reached 80%, and a viscosity value when there was no change in torque was measured with a plate rheometer (LVDV-III Ultra, manufactured by Brookfield Engineering Labs., Inc.). At this time, the viscosity was measured under a temperature condition of 25° C. using a 52Z spindle. A unit of the viscosity is cp.

2. Yellow Index (YI)

A yellow index was measured in accordance with the ASTM E313 standard using a spectrophotometer (COH-5500, manufactured by Nippon Denshoku Industries Co., Ltd.).

3. Retardation (Rth)

A retardation was measured using Axoscan (OPMF, manufactured by Axometrics Inc.). A thickness direction retardation (Rth) was measured at a wavelength of 550 nm, and the thickness direction retardation (Rth) at a wavelength of 550 nm was indicated by an absolute value. A unit of the retardation is nm.

4. Modulus and Elongation at Break

A modulus and an elongation at break were measured using a specimen having a thickness of 50 μm, a length of 50 mm, and a width of 10 mm according to ASTM E111 under a condition in which the specimen was pulled at 25° C. and 50 mm/min using UTM 3365 (manufactured by Instron Corporation). A unit of the modulus is GPa, and a unit of the elongation at break is %

### EXAMPLE 1

### Production of Polyamideimide Film

N,N-dimethylpropionamide (DMPA) and 2,2′-bis(trifluoromethyl)benzidine (TFMB) were added to a reactor, the mixture was sufficiently stirred in a nitrogen atmosphere, and then terephthaloyl chloride (TPC) was added and stirred for 6 hours to be dissolved and react. Therefore, the reaction product obtained by precipitation and filtration using an excessive amount of methanol was vacuum dried at 50° C. for 6 hours or longer, the dried reaction product was added to and dissolved in the reactor together with DMPA in a nitrogen atmosphere again, and then 9,9-bis(3,4-dicarboxyphenyl)fluorene dianhydride (BPAF) was added and stirred for 12 hours to be dissolved and react, thereby preparing a polyamic acid resin composition. At this time, the molar ratio of monomers of TFMB:BPAF:TPC was adjusted to 100:90:10, and a solid content was adjusted to 15 wt %, thereby preparing a polyamideimide film-forming composition.

The obtained polyamideimide film-forming composition was applied to one surface of a glass substrate (1.0 T) with a mayer bar, drying was performed in a nitrogen atmosphere at 80° C. for 15 minutes, heating was performed at 300° C. for 15 minutes to cure the polyamideimide film-forming composition, and then the cured polyamideimide film-forming composition was peeled off from the glass substrate, thereby producing a polyamideimide film having a thickness of 50 μm.

### EXAMPLES 2 and 3

### Production of Polyamideimide Film

Polyamideimide films having a thickness of 50 μm of Examples 2 and 3 were produced in the same manner as that of Example 1, except that the molar ratio of TFMB, BPAF, and TPC was changed as shown in Table 1.

### EXAMPLES 4 and 5

### Production of Polyamideimide Film

Polyamideimide films having a thickness of 50 μm of Examples 4 and 5 were produced in the same manner as that of Example 1, except that isophthaloyl chloride (IPC) was used instead of TPC and the molar ratio of TFMB, BPAF, and IPC was changed as shown in Table 1.

### EXAMPLE 6

### Production of Polyamideimide Film

A polyamideimide film having a thickness of 50 μm of Example 6 was produced in the same manner as that of Example 1, except that the heat treatment temperature was changed as shown in Table 1.

### REFERENCE EXAMPLES 1 and 2

### Production of Polyamideimide Film

Polyamideimide films having a thickness of 50 μm of Reference Examples 1 and 2 were produced in the same manner as that of Example 1, except that the molar ratio of TFMB, BPAF, and TPC was changed as shown in Table 1.

### REFERENCE EXAMPLES 3 and 4

### Production of Polyamideimide Film

Polyamideimide films having a thickness of 50 μm of Reference Examples 3 and 4 were produced in the same manner as that of Example 1, except that the molar ratio of TFMB, BPAF, and TPC was changed as shown in Table 1 and the heat treatment temperature was changed as shown in Table 1.

### COMPARATIVE EXAMPLE 1

### Production of Polyamideimide Film

A polyamideimide film having a thickness of 50 μm of Comparative Example 1 was produced in the same manner as that of Example 1, except that 2,2′-bis(3,4-dicarboxyphenyl)hexafluoropropane dianhydride (6FDA) was used instead of BPAF and the molar ratio of TFMA, 6FDA, and TPC was changed as shown in Table 1.

### COMPARATIVE EXAMPLE 2

### Production of Polyamideimide Film

A polyamideimide film having a thickness of 50 μm of Comparative Example 2 was produced in the same manner as that of Example 1, except that 2,5-furandicarbonyl dichloride (FDCAC1) was used instead of TPC and the molar ratio of TFMA, BPAF, and FDCAC1 was changed as shown in Table 1.

TABLE 1

| | | | | | | | Heat |
|---|---|---|---|---|---|---|---|
| | | | | | | | treatment |
| | | | | | | | temper- |
| | | | | | | | ature |
| | TFMB | BPAF | 6FDA | TPC | IPC | FDCACl | (° C.) |
| Example 1 | 100 | 90 | — | 10 | — | — | 300 |
| Example 2 | 100 | 80 | — | 20 | — | — | 300 |
| Example 3 | 100 | 60 | — | 40 | — | — | 300 |
| Example 4 | 100 | 80 | — | — | 20 | — | 300 |
| Example 5 | 100 | 60 | — | — | 40 | — | 300 |
| Example 6 | 100 | 90 | — | 10 | — | — | 350 |
| Reference | 100 | 40 | — | 60 | — | — | 300 |
| Example 1 | | | | | | | |
| Reference | 100 | 20 | — | 80 | — | — | 300 |
| Example 2 | | | | | | | |
| Reference | 100 | 80 | — | 20 | — | — | 280 |
| Example 3 | | | | | | | |
| Reference | 100 | 80 | — | 20 | — | — | 390 |
| Example 4 | | | | | | | |
| Comparative | 100 | — | 80 | 20 | — | — | 300 |
| Example 1 | | | | | | | |
| Comparative | 100 | 80 | — | — | — | 20 | 300 |
| Example 2 | | | | | | | |

### EXAMPLE 7

### Preparation of Polyamideimide Film-Forming Composition

N,N-dimethylpropionamide (DMPA) and 2,2′-bis(trifluoromethyl)benzidine (TFMB) were added to a reactor, the mixture was sufficiently stirred in a nitrogen atmosphere, and then terephthaloyl chloride (TPC) was added and stirred for 6 hours to be dissolved and react. Therefore, the reaction product obtained by precipitation and filtration using an excessive amount of methanol was vacuum dried at 50° C. for 6 hours or longer, the dried reaction product was added to and dissolved in the reactor together with DMPA in a nitrogen atmosphere again, and then 9,9-bis(3,4-dicarboxyphenyl)fluorene dianhydride (BPAF) was added and stirred for 12 hours to be dissolved and react, thereby preparing a polyamic acid resin composition. In this case, the molar ratio of monomers of TFMB:BPAF:TPC was set to 100:90:10.

After the mixture was stirred for 6 hours, toluene was added at 25° C., and the mixture was stirred for 18 hours. Thereafter, a mixed solvent of DPMA and toluene was added so that a solid content was 17 wt % with respect to the total weight of the composition and a content of toluene in the composition was DMPA:toluene =70 wt %:30 wt %, thereby preparing a polyamideimide film-forming composition.

Production of Polyamideimide Film

The obtained polyamideimide film-forming composition was applied to one surface of a glass substrate (1.0 T) with a mayer bar, drying was performed in a nitrogen atmosphere at 80° C. for 15 minutes, heating was performed at 300° C. for 15 minutes to cure the polyamideimide film-forming composition, and then the cured polyamideimide film-forming composition was peeled off from the glass substrate, thereby producing a polyamideimide film having a thickness of 50 μm of Example 7.

### EXAMPLES 8 and 9

Polyamideimide film-forming compositions of Examples 8 and 9 were prepared in the same manner as that of Example 7, except that the molar ratio of TFMB, BPAF, and TPC was changed as shown in Table 2, and polyamideimide films each having a thickness of 50 μm of Examples 8 and 9 were produced in the same manner as that of Example 7.

### EXAMPLES 10 and 11

Polyamideimide film-forming compositions of Examples 10 and 11 were prepared in the same manner as that of Example 7, except that isophthaloyl chloride (IPC) was used instead of TPC and the molar ratio of TFMB, BPAF, and IPC and the content of toluene were changed as shown in Table 2, and polyamideimide films each having a thickness of 50 μm of Examples 10 and 11 were produced in the same manner as that of Example 7.

### EXAMPLE 12

A polyamideimide film-forming composition of Example 12 was prepared in the same manner as that of Example 7, except that the content of toluene was changed as shown in Table 2, and a polyamideimide film having a thickness of 50 μm of Example 12 was produced in the same manner as that of Example 7, except that the heat treatment temperature was changed as shown in Table 2.

### REFERENCE EXAMPLES 5 to 7

Polyamideimide film-forming compositions of Reference Examples 5 to 7 were prepared in the same manner as that of Example 7, except that the molar ratio of TFMB, BPAF, and TPC and the content of toluene were changed as shown in Table 2, and polyamideimide films each having a thickness of 50 μm of Reference Examples 5 to 7 were produced in the same manner as that of Example 7.

TABLE 2

| | | | | | | Heat |
|---|---|---|---|---|---|---|
| | | | | | | treatment |
| | | | | | Toluene | temperature |
| | TEMB | BPAF | TPC | IPC | (wt % ) | (° C.) |
| Example 7 | 100 | 90 | 10 | — | 30 | 300 |
| Example 8 | 100 | 80 | 20 | — | 30 | 300 |
| Example 9 | 100 | 60 | 40 | — | 30 | 300 |
| Example 10 | 100 | 80 | — | 20 | 30 | 300 |
| Example 11 | 100 | 60 | — | 40 | 25 | 300 |
| Example 12 | 100 | 90 | 10 | — | 45 | 350 |
| Reference | 100 | 90 | 10 | — | 60 | 300 |
| Example 5 | | | | | | |
| Reference | 100 | 90 | 10 | — | 15 | 300 |
| Example 6 | | | | | | |
| Reference | 100 | 40 | 60 | — | 30 | 300 |
| Example7 | | | | | | |

<Experimental Example>Evaluation of Optical Properties and Mechanical Properties

The viscosity, yellow index (YI), thickness direction retardation (Rth), modulus, and elongation at break of each of the polyamideimide films according to Examples, Reference Examples, and Comparative Examples were measured according to the measurement methods. The results are shown in Tables 3 and 4.

TABLE 3

| | Example No. | | | | | |
|---|---|---|---|---|---|---|
| | 1 | 2 | 3 | 4 | 5 | 6 |
| Thickness | 50 | 50 | 50 | 50 | 50 | 50 |
| (μm) | | | | | | |
| Modulus | 4.2 | 4.4 | 4.7 | 4.1 | 4.1 | 4.5 |
| (GPa) | | | | | | |
| Rth | 383 | 453 | 490 | 307 | 338 | 358 |
| (550 nm) | | | | | | |
| Yellow | 2.9 | 3.3 | 3.4 | 2.8 | 3.2 | 3.2 |
| index | | | | | | |
| (YI) | | | | | | |
| Elongation | 11 | 13 | 17 | 13 | 16 | 15 |
| at break | | | | | | |
| (%) | | | | | | |
| | | | | | Comparative | |
| | Reference Example No. | | | | Example No. | |
| | 1 | 2 | 3 | 4 | 1 | 2 |
| Thickness | 50 | 50 | 50 | 50 | 50 | 50 |
| (μm) | | | | | | |
| Modulus | 4.9 | 5.2 | 3.7 | 4.5 | 3.9 | 3.5 |
| (GPa) | | | | | | |
| Rth | 1081 | 1800 | 800 | 620 | 620 | 460 |
| (550 nm) | | | | | | |
| Yellow | 4.8 | 5.5 | 2.7 | 8.5 | 2.9 | 8 . 8 |
| index | | | | | | |
| (YI) | | | | | | |
| Elongation | 18 | 18 | 12 | 18 | 16 | 8 |
| at break | | | | | | |
| (%) | | | | | | |

TABLE 4

| | Example No. | | | | | |
|---|---|---|---|---|---|---|
| | 7 | 8 | 9 | 10 | 11 | 12 |
| Thickness | 50 | 50 | 50 | 50 | 50 | 50 |
| (μm) | | | | | | |
| Viscosity | 10,500 | 10,500 | 12,500 | 8,900 | 7, 400 | 9,200 |
| (V_{PAI}, cp) | | | | | | |
| Yellow | 2.4 | 2.9 | 2.9 | 2.5 | 2.8 | 2.5 |
| index | | | | | | |
| (YI) | | | | | | |
| Rth | 340 | 440 | 420 | 290 | 301 | 330 |
| (550 nm) | | | | | | |
| Modulus | 4.1 | 4.2 | 4.4 | 4.0 | 4.0 | 4.0 |
| (GPa) | | | | | | |

| | Reference Example No. | | |
|---|---|---|---|
| | 5 | 6 | 7 |
| Thickness | Polymerization | 50 | 50 |
| (μm) | is impossible | | |
| Viscosity | due to | 16,500 | 14,500 |
| (V_{PAI}, cp) | increase in | | |
| Yellow | initial | 2.9 | 4.6 |
| index | viscosity | | |
| (YI) | | | |
| Rth | | 380 | 1,010 |
| (550 nm) | | | |
| Modulus | | 4.2 | 4.8 |
| (GPa) | | | |

As can be seen from Tables 3 and 4, the polyamideimide films according to Examples have a low thickness direction retardation in the visible light region, such that reflective appearance may be remarkably improved, and the polyamideimide films have high strength properties and a high elongation at break, such that the polyamideimide film may be suitably applied to a display device, and is useful, for example, as a cover window for a foldable or flexible display device.

On the other hand, in Comparative Example 1 in which 6FDA was contained instead of BPAF as an dianhydride, a relatively low yellow index was exhibited, but a thickness direction retardation was 620 nm, which was significantly higher than that of the film of each of Examples, and a modulus value was low. In addition, in Comparative Example 2 in which FDCAC1 was contained instead of TPC or IPC as an diacid dichloride, a yellow index was 8.8, which was significantly high, and an elongation at break was low, such that excellent mechanical properties could not be secured.

Furthermore, even in a case where a polyamideimide film was produced using a mixed solvent including an amide-based solvent and a hydrocarbon-based solvent, it could be confirmed that a low thickness direction retardation and a high modulus were implemented, and in particular, a yellow index was lower than that in the film produced using a single solvent.

As set forth above, the polyamideimide film according to one embodiment may significantly prevent a mura phenomenon that causes deterioration of visibility, in particular, a rainbow phenomenon caused by a retardation. In addition, the polyamideimide film may implement colorless and transparent optical properties even in a thickness range in which the polyamideimide film has mechanical strength similar to that of tempered glass. Furthermore, the polyamideimide film has a low thickness direction retardation (Rth) in a wide visible ray region, such that reflective appearance may be remarkably improved. At the same time, the polyamideimide film has excellent bending properties as well as high strength properties, such that breakage and cracks due to bending may be prevented. Therefore, the polyamideimide film according to one embodiment may be effectively applied to optical application such as a foldable display device or a flexible display device.

Hereinabove, although one embodiment has been described by a limited Example, one embodiment has been provided only for assisting in a more general understanding of one embodiment. Therefore, one embodiment is not limited to the Examples. Various modifications and changes may be made by those skilled in the art described in the present specification from this description.

Therefore, the spirit of the present disclosure should not be limited to the described embodiments, but the claims and all modifications equal or equivalent to the claims are intended to fall within the spirit of the present disclosure.

1. A polyamideimide film comprising:
a diamine-derived structural unit;
a dianhydride-derived structural unit; and
a diacid dichloride-derived structural unit,
wherein the diamine-derived structural unit includes a structural unit derived from a compound represented by the following Chemical Formula 1,
the dianhydride-derived structural unit includes a structural unit derived from a compound represented by the following Chemical Formula 2,
the diacid dichloride-derived structural unit includes a structural unit derived from any one of a compound represented by the following Chemical Formula 3 and a compound represented by the following Chemical Formula 4, and
the polyamideimide film has a thickness of 30 μm to 100 μm, a modulus of 4.0 GPa or more when measured according to ASTM E111, and an absolute value of a thickness direction retardation (Rth) of 600 nm or less when measured at a wavelength of 550 nm:

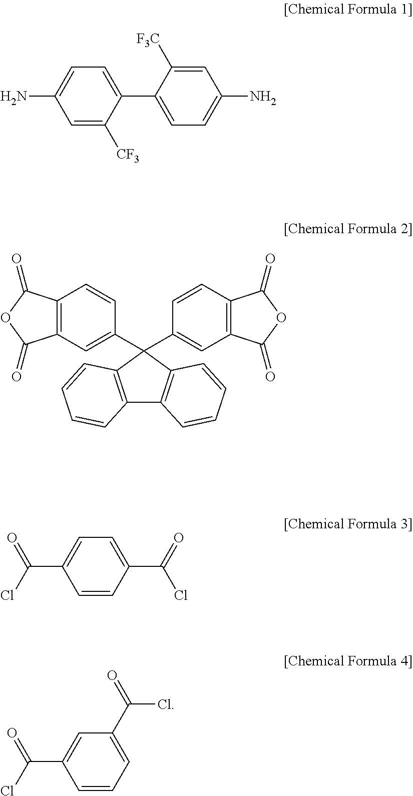 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

2. The polyamideimide film of claim 1, wherein the polyamideimide film has a yellow index (YI) of 4.0 or less when measured according to ASTM E313.

3. The polyamideimide film of claim 1, wherein the polyamideimide film has an elongation at break of 10% or more.

4. The polyamideimide film of claim 1, wherein the thickness of the polyamideimide film is 40 μm to 80 μm, and the absolute value of the thickness direction retardation of the polyamideimide film is 200 nm to 500 nm when measured at the wavelength of 550 nm.

5. The polyamideimide film of claim 1, wherein the diacid dichloride-derived structural unit is included in an amount of 5 mol % to 50 mol % with respect to 100 mol % of the diamine-derived structural unit, and a molar ratio of the dianhydride-derived structural unit and the diacid dichloride-derived structural unit is 95:5 to 50:50.

6. A polyamideimide film-forming composition comprising:
polyamic acid or polyamideimide including a diamine-derived structural unit, a dianhydride-derived structural unit, and a diacid dichloride-derived structural unit; and
a mixed solvent including an amide-based solvent and a hydrocarbon-based solvent,
wherein the polyamideimide film-forming composition satisfies the following Expression 1, and the diamine-derived structural unit includes a structural unit derived from a compound represented by the following Chemical Formula 1, the dianhydride-derived structural unit includes a structural unit derived from a compound represented by the following Chemical Formula 2, and the diacid dichloride-derived structural unit includes a structural unit derived from any one of a compound represented by the following Chemical Formula 3 and a compound represented by the following Chemical Formula 4: 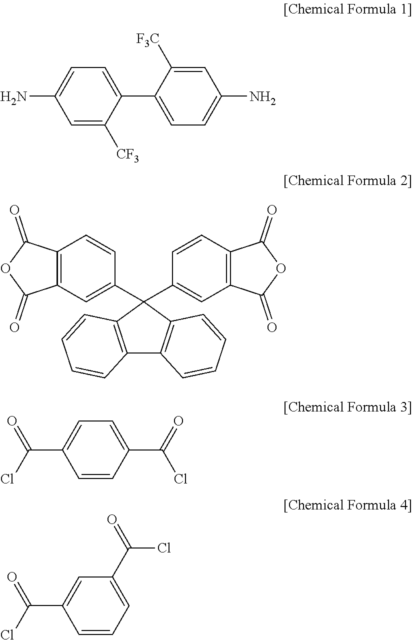
5,000 ≤V_{PAI} ≤15,000 [Expression 1]
wherein
V_{PAI} is a viscosity of the polyamideimide film-forming composition when a solid content is 17 wt % with respect to a total weight of the polyamideimide film-forming composition, and the viscosity is a viscosity (unit: cp) measured at 25° C. with a Brookfield rotational viscometer using a 52Z spindle based on a torque of 80% and a time of 2 minutes.

7. The polyamideimide film-forming composition of claim 6, wherein the amide-based solvent contains dimethylpropionamide.

8. The polyamideimide film-forming composition of claim 6, wherein the hydrocarbon-based solvent is a cyclic hydrocarbon-based solvent.

9. The polyamideimide film-forming composition of claim 8, wherein the cyclic hydrocarbon-based solvent contains toluene, benzene, cyclohexane, or a combination thereof.

10. The polyamideimide film-forming composition of claim 6, wherein a solid in the polyamideimide film-forming composition is contained in an amount of 10 wt % to 40 wt % with respect to the total weight of the polyamideimide film-forming composition.

11. The polyamideimide film-forming composition of claim 6, wherein the polyamideimide film-forming composition contains the amide-based solvent and the hydrocarbon-based solvent at a weight ratio of 8:2 to 5:5.

12. The polyamideimide film-forming composition of claim 6, wherein the diacid dichloride-derived structural unit is included in an amount of 5 mol % to 40 mol % with respect to 100 mol % of the diamine-derived structural unit, and a molar ratio of the dianhydride-derived structural unit and the diacid dichloride-derived structural unit is 95:5 to 50:50.

13. A method of preparing a polyamideimide film-forming composition, the method comprising the steps of:
preparing a polyamic acid solution by reacting a diamine containing a compound represented by the following Chemical Formula 1, a dianhydride containing a compound represented by the following Chemical Formula 2, and a diacid dichloride containing any one of a compound represented by the following Chemical Formula 3 and a compound represented by the following Chemical Formula 4 with each other in an amide-based solvent (step i); and
adjusting a viscosity by adding a hydrocarbon-based solvent to satisfy Expression 1 (step ii): 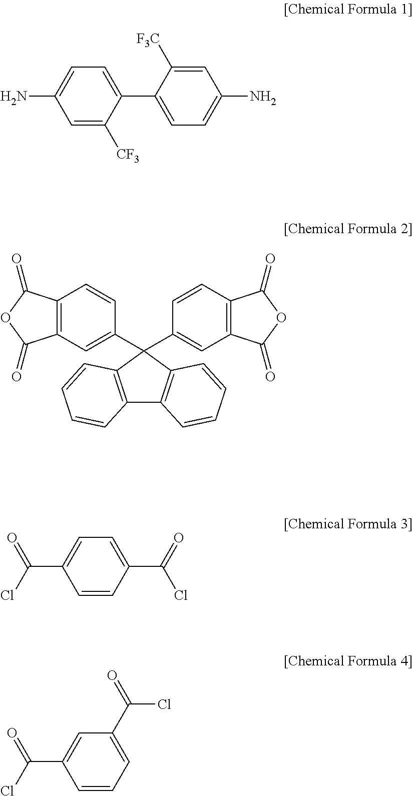 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]
5,000 ≤V_{PAI} ≤15,000 [Expression 1]
wherein
V_{PAI} is a viscosity of the polyamideimide film-forming composition when a solid content is 17 wt % with respect to a total weight of the polyamideimide film-forming composition, and the viscosity is a viscosity (unit: cp) measured at 25° C. with a Brookfield rotational viscometer using a 52Z spindle based on a torque of 80% and a time of 2 minutes.

14. The method of claim 13, wherein step ii includes:
adding a hydrocarbon-based solvent in an amount of 25 wt % to 100 wt % with respect to a weight of the amide-based solvent, and stirring the mixture; and
additionally adding a mixed solvent including an amide-based solvent and a hydrocarbon-based solvent to satisfy Expression 1.

15. The method of claim 13, wherein the amount of the diacid dichloride is 5 mol % to 50 mol % with respect to 100 mol % of the diamine, and a molar ratio of the dianhydride and the diacid dichloride is 95:5 to 50:50.

16. A method of producing a polyamideimide film, the method comprising performing a heat treatment after applying the polyamideimide film-forming composition according to claim 6 to a substrate.

17. The method of claim 16, wherein in the performing of the heat treatment, the heat treatment is performed at 300° C. to 350° C. for 10 minutes to 60 minutes.

18. The method of claim 16, further comprising, before the performing of the heat treatment, drying the polyamideimide film-forming composition at 50° C. to 150° C.

19. A cover window for a display device comprising:
the polyamideimide film according to claim 1; and
a coating layer disposed on the polyamideimide film.

20. A display device comprising the polyamideimide film according to claim 1.
